(19) United States
(12) Patent Application Publication
(10) Pub. No.: US 2023/0106706 A1
(43) Pub. Date: Apr. 6, 2023

(54) GENERATIVE ADVERSARIAL NETWORKS (GANs) BASED IDENTIFICATION OF AN EDGE SERVER

(71) Applicant: INTERNATIONAL BUSINESS MACHINES CORPORATION, Armonk, NY (US)

(72) Inventors: Mari Abe Fukuda, Tokyo (JP); Yasutaka Nishimura, Yamato-shi (JP); Shoichiro Watanabe, Tokyo (JP); Kenichi Takasaki, Tokyo (JP); Sanehiro Furuichi, Tokyo (JP)

(21) Appl. No.: 17/486,211

(22) Filed: Sep. 27, 2021

(51) Int. Cl. G06N 3/04; G06N 5/04; G06N 3/08

(52) U.S. Cl. CPC G06N 3/0454; G06N 3/08; G06N 5/043

(57) ABSTRACT

Provided are techniques for a Generative Adversarial Networks (GANs) based identification of an edge server. At a first edge server, a global discriminator that has been trained with common data is received. It is determined that area data is imbalanced using the global discriminator. A local discriminator is trained with the area data to generate a first result. An exchanged local discriminator from a second edge server is trained with the area data to generate a second result. The first result and the second result indicate that the first edge server and the second edge server are proximate. The first edge server and the second edge server are added to an edge server group list. At least one of an application model and a configuration of an application is updated from one of the first edge server and the second edge server, and the application is executed.

### BACKGROUND

Embodiments of the invention relate to a Generative Adversarial Networks (GANs) based identification of an edge server. In particular, embodiments of the invention relate to a GANs-based imbalanced data area identification of an edge server.

An edge computing environment may be described as a distributed computing concept that integrates intelligence to edge devices and allows data to be processed and analyzed in real time at the edge device, which is typically near the data collection source.

In some cases, data-driven applications are executing in the edge computing environment. If these data-driven applications are configured from common data, they may result in application errors when used with other data.

### SUMMARY

In accordance with certain embodiments, a computer-implemented method is provided for GANs based identification of an edge server. The computer-implemented method comprises operations. At a first edge server, a global discriminator that has been trained with common data is received. It is determined that area data is imbalanced using the global discriminator. A local discriminator is trained with the area data to generate a first result. An exchanged local discriminator is received from a second edge server. The exchanged local discriminator is trained with the area data to generate a second result. It is determined that the first result and the second result indicate that the first edge server and the second edge server are proximate. The first edge server and the second edge server are added to an edge server group list. At least one of an application model and a configuration of an application is updated from one of the first edge server and the second edge server on the edge server group list, and the application is executed.

In accordance with certain embodiments, a computer program product is provided for GANs based identification of an edge server. The computer program product comprises a computer readable storage medium having program code embodied therewith, the program code executable by at least one processor to perform operations. At a first edge server, a global discriminator that has been trained with common data is received. It is determined that area data is imbalanced using the global discriminator. A local discriminator is trained with the area data to generate a first result. An exchanged local discriminator is received from a second edge server. The exchanged local discriminator is trained with the area data to generate a second result. It is determined that the first result and the second result indicate that the first edge server and the second edge server are proximate. The first edge server and the second edge server are added to an edge server group list. At least one of an application model and a configuration of an application is updated from one of the first edge server and the second edge server on the edge server group list, and the application is executed.

In accordance with certain embodiments, a computer system is provided for GANs based identification of an edge server. The computer system comprises one or more processors, one or more computer-readable memories and one or more computer-readable, tangible storage devices; and program instructions, stored on at least one of the one or more computer-readable, tangible storage devices for execution by at least one of the one or more processors via at least one of the one or more memories, to perform operations. At a first edge server, a global discriminator that has been trained with common data is received. It is determined that area data is imbalanced using the global discriminator. A local discriminator is trained with the area data to generate a first result. An exchanged local discriminator is received from a second edge server. The exchanged local discriminator is trained with the area data to generate a second result. It is determined that the first result and the second result indicate that the first edge server and the second edge server are proximate. The first edge server and the second edge server are added to an edge server group list. At least one of an application model and a configuration of an application is updated from one of the first edge server and the second edge server on the edge server group list, and the application is executed.

Thus, embodiments advantageously allow grouping of edge servers that are proximate using GANs and selection of an application model and/or a configuration of an application from one of the edge servers in the group.

In accordance with additional embodiments, under control of the first edge server, a request to execute the application from an edge device is received, it is determined that a load is high, and the request is forwarded to another edge server on the edge server group list. This advantageously allows for load balancing.

In accordance with yet additional embodiments, under control of an edge device, it is determined that the edge device is approaching an area of coverage of the first edge server, and the edge server group list is requested from the first edge server. In response to determining that at least one of an application model and a configuration of another application is not from any edge server on the edge server group list, at least one of a new application model and a new configuration is requested from the first edge server. The another application is executed using the at least one of the new application model and the new configuration. This advantageously allows the edge device to obtain updates to the application model and/or configuration from one of the edge servers in the edge server group list.

In accordance with further embodiments, an edge device maintains a visited edge servers list while traversing a path that passes by at least one of the first edge server and the second edge server. This advantageously allows the edge servers that the edge device has visited to be remembered.

In accordance with yet further embodiments, an exchanged local discriminator is received, from a third edge server, and the exchanged local discriminator from the third edge server is trained with the area data to generate a third result. It is determined that the first result and the third result indicate that the first edge server and the third edge server are not proximate. This advantageously allows determination of edge servers that are not proximate so that the are not added to the edge server group list.

In yet further embodiments, the global discriminator outputs a negative result to indicate that the area data is imbalanced and outputs a positive result to indicate that the area data is not imbalanced. This advantageously allows for easy determination of whether the area data is imbalanced using the output of the global discriminator.

In more embodiments, the global discriminator is trained at a cloud node and deployed to the first edge server. This advantageously allows for a cloud node and the first edge server to cooperate and moves the generation of the global discriminator to the cloud node, which may deploy that global discriminator to a plurality of edge servers.

In yet more embodiments, a Software as a Service (SaaS) is configured to perform the operations to update and execute the application. This advantageously allows a service to be provided to perform the operations.

### BRIEF DESCRIPTION OF THE SEVERAL VIEWS OF THE DRAWINGS

Referring now to the drawings in which like reference numbers represent corresponding parts throughout:

FIG. 1 illustrates, in a block diagram, a computing environment in accordance with certain embodiments.

FIG. 2 illustrates an example of edge devices that are automobiles in accordance with certain embodiments.

FIG. 3 illustrates, in a flowchart, operations for training a global discriminator and distributing the global discriminator to edge servers in accordance with certain embodiments.

FIG. 4 illustrates, in a flowchart, operations for creating an edge server group list at an edge server in accordance with certain embodiments.

FIG. 5 illustrates, in a flowchart, operations for executing an application on an edge device in accordance with certain embodiments.

FIG. 6 illustrates, in a flowchart, operations for executing an application on an edge server in accordance with certain embodiments.

FIGS. 7A and 7B illustrate, in a flowchart, operations for updating an application model and configuration of that application model and executing an application in accordance with certain embodiments.

FIG. 8 illustrates a computing node in accordance with certain embodiments.

FIG. 9 illustrates a cloud computing environment in accordance with certain embodiments.

FIG. 10 illustrates abstraction model layers in accordance with certain embodiments.

### DETAILED DESCRIPTION

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

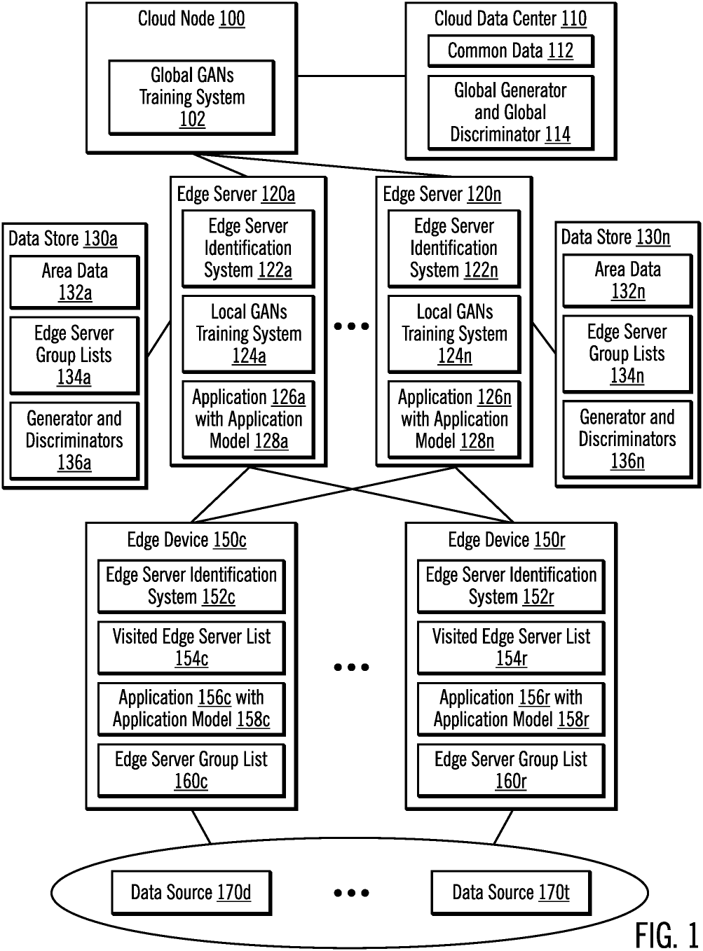

FIG. 1 illustrates, in a block diagram, a computing environment in accordance with certain embodiments. A cloud node 100 is coupled to a cloud data center 110 and to edge servers 120a... 120n. In certain embodiments, an edge server 120a... 120n is a Multi-access Edge Computing (MEC) server. An MEC environment may be described as providing cloud-computing capabilities and an Information Technology (IT) service environment at the edge of the network. The cloud node 100 includes a global GANs training system 102, and the cloud data center 110 includes common data 112 and a global generator and global discriminator 114 of a GANs. The common data may be described as global. The common data 112 may be collected from wide range of situations. For example, the common data 112 may include training data of driving videos/images captured by on-board cameras and used by autonomous vehicles. The common data 112 may cover weather (e.g., sunny, rainy, snowy, etc.). In certain embodiments, the common data 112 is common to the specific area that is covered by the edge servers 120a... 120n.

Each of the edge servers 120a... 120n is connected to a data store 130a... 130n. Each of the edge servers 120a... 120n includes an edge server identification system 122a... 122n, a local GANs training system 124a... 124n, and at least one application 126a... 126n with an application model 128a... 128n. Each of the data stores 130a... 130n stores area data 132a... 132n, edge server group lists 134a... 134n, and a generator and discriminators 136a... 136n. The generator and discriminators 136a... 136n include a local generator and a local discriminator of the GAN of that edge server 120a... 120n, the global discriminator of the GANs of the cloud node 100, and local discriminators from other edge servers. Examples of applications include: image recognition for object detection, scoring of good driving, obstacle identification, etc,

In certain embodiments, the edge servers 120a... 120n are connected to the edge devices 150c... 150r via one or more networks, such as a Radio Access Network (RAN). The edge devices 150c... 150r may be described as end-point devices. Each of the edge servers 120a... 120n covers a geographic area and may work with other edge servers 120a... 120n to perform operations (such as object detection).

Each of the edge devices 150c... 150r includes an edge server identification system 152c... 152r, a visited edge server list 154c... 154r, and at least one application 156c... 156r with an application model 158c... 158r. Each of the edge devices 150c... 150r may receive data from one or more data sources 170d... 170t. The edge devices 150c... 150r may be vehicles with computers (e.g., cars, boats, bicycles, buses, etc.), smartphones, edge servers, mobile devices, etc. In certain embodiments, the data sources 170d... 170t are sensors (e.g., of a car, on clothing, on buildings, on roads, etc.), Internet of Things (IoT) devices, Internet of Everything (IoE) devices, data stores, databases, etc. A set of data from the data sources 170d... 170t may be described as including one or more data elements.

In certain embodiments, each of the edge servers 120a... 120n provides a set of middleware services to the applications 156c... 156r, such as communication services and a service registry. The end-point edge devices 150c... 150r may access an edge server 120a... 120n when the edge devices 150c... 150r enter the physical area covered by that edge server 120a... 120n. The edge servers 120a... 120n store geospatial data and area data 132a... 132n to offer services that are specific to the area’s features.

In certain embodiments, imbalanced data refers to statistically biased data. Examples of area data 132a... 132n that is imbalanced data in autonomous vehicle domains appear as time-series sensor data, such as: average speed of vehicles, behavior patterns of driving, patterns based on traffic regulations, etc. Such area data 132a... 132n is specific to the area’s features and influences predictions (e.g., a prediction of dangerous driving, such as harsh breaking and sudden accelerations). Other types of area data 132a... 132n that is imbalanced in the autonomous vehicle domains appears as image data, such as: image data showing fog, snow, dusk, light pollution, etc. in the specific area. This image data influences object detection based on the image data by the applications 126a... 126n, 156c... 156r using the application models 128a... 128n, 158c... 158r. In certain embodiments, the edge services and applications 126a...126n, 156c... 156r are data-driven applications with application models 128a... 128n, 158c... 158r that are configured from and/or trained with the common data, and the applications 126a...126n, 156c... 156r may have application errors when these application models 128a... 128n, 158c... 158r are used with the area data. Thus, embodiments identify each edge server 120a... 120n that has area data that is imbalanced by training a discriminator with common data (referred to as a global discriminator) on the cloud node 100 and deploying that global discriminator to each edge server 120a... 120n. Then, the local GANs training system 124a... 124n on each edge server 120a... 120n trains the GANs with the area data that is imbalanced to generate a local discriminator. The edge servers 120a... 120n exchange these local discriminators. In certain embodiments, edge servers 120a... 120n that are adjacent exchange the local discriminators.

In addition, the edge server identification system 122a... 122n groups edge servers 120a... 120n into an edge server group that have proximate data (e.g., similar data for the area of coverage of the edge servers 120a... 120n) based on the result of the local discriminators. Proximate data may be described as data for the same or adjacent area as that covered by the edge servers 120a... 120n.

Embodiments also configure the application models 128a... 128n, 158c... 158r of the applications 126a... 126n, 156c... 156r that are executed on either an edge server 120a... 120n or an end-point device 150c... 150r based on the edge server group list 134a... 134n, while communicating between the edge server 120a... 120n and end-point devices 150c... 150r with the edge server group list information when any end-point device 150c... 150r is approaching (or entering) the area of coverage of an edge server 120a... 120n. For example, for an application for image recognition by a machine learning model, configuring the application model may include setting an identifier of the machine learning model (e.g., a name and the version of the machine learning model). As another example, for an application for scoring driving behavior that is executed by compiled code, configuring the application model may include setting configuration parameters, such as an upper bound of hard breaking.

GANs is a type of machine learning with two neural networks. The two neural networks are a generative network (generator) that generates artificial data that has similar distribution to the data that is used for training and a discriminative network (discriminator) that evaluates data if it likely to be the training data.. The common data (which may be described as a training data set or an initial data set) serves as the initial training data for the global generator G_{c} and the global discriminator D_{c}. Then, the global discriminator D_{c} may be used at an edge server to determine whether the area data is imbalanced. If the area data is imbalanced, the edge server then trains a local GANs (which is a local generator G and a local discriminator D) with the area data. The local discriminator D may be sent to other edge servers, which return the result if the distribution is likely to be the trained data or not. The local discriminators may be used at each of the edge servers to determine whether the area data is imbalanced with respect to the local discriminator of another edge server. If two edge servers each find that the area data is not imbalanced based on the exchanged local discriminators, then the two edge servers may be included in an edge server group.

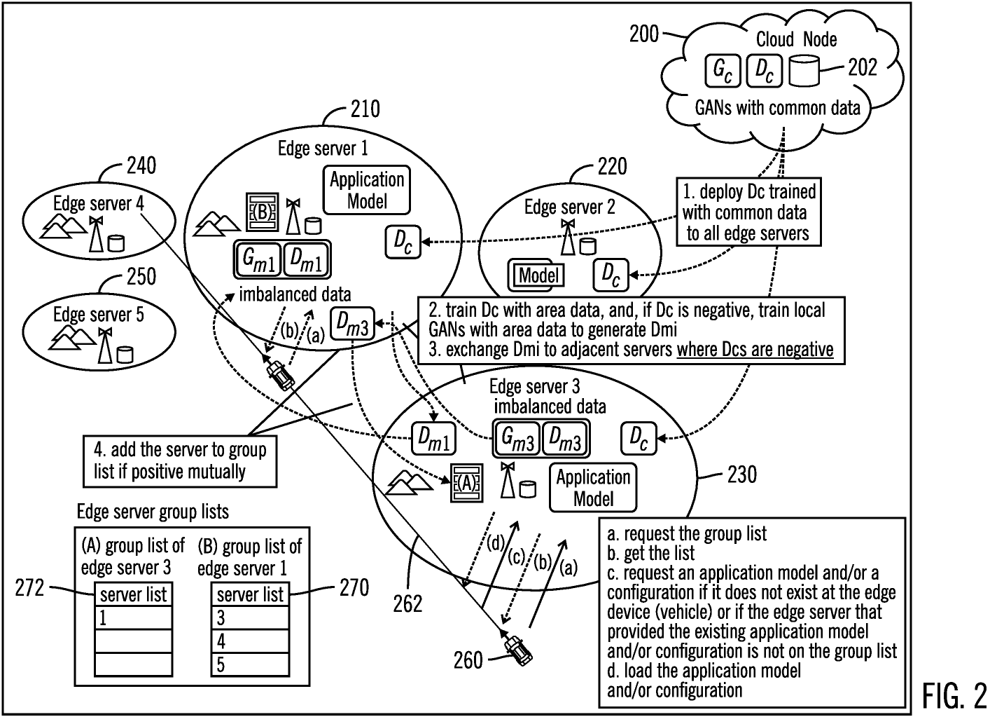

FIG. 2 illustrates an example of edge devices that are automobiles in accordance with certain embodiments. In FIG. 2, a cloud node 200 is connected to edge servers 210, 220, 230, 240, 250. An edge device 260, which is a vehicle in this example, is traveling along a path 262. The path 262 passes through different areas of coverage of the edge servers 210, 220, 230, 240, 250.

Initially, the global GANs training system at the cloud node 200 trains the global generator G_{c} and the global discriminator D_{c} with common data 202 from the cloud data center. Then, the global GANs training system at the cloud node 200 deploys the global discriminator D_{c} to the edge servers 210, 220, 230. Although not shown in this example, the global discriminator D_{c} may also be deployed to the edge servers 240, 250. Each of the edge servers 210, 220, 230 uses the global discriminator D_{c} to determine whether the area data at that edge server 210, 220, 230 is imbalanced. In particular, inputting area data into the global discriminator D_{c} results in either a negative result (indicating that the area data is imbalanced) or a positive result (indicating that the area data is not imbalanced). The global discriminator D_{c} compares the area data to the common data to generate the result.

In the example of FIG. 2, at each edge server 210 and 230, inputting area data into the global discriminator D_{c} results in an indication that the area data is imbalanced. Then, the local GANs training system at each edge server where Dc resulted in a negative result (indicating that the area data is imbalanced, 210 and 230 in this example) trains the GANs with area data to generate a local generator Gₘᵢ and a local discriminator Dₘᵢ and exchanges the local discriminators Dₘᵢ with other edge servers where Dc results in negative (210 and 230). That is, the local GANs is created when the D_{c} detects that the area data is imbalanced.

For example, in FIG. 2, at edge server 210, the local GANs training system receives the local discriminator Dₘ₃ from edge server 230, evaluates the area data of edge server 210 with the discriminator Dₘ₃, receives a positive result from discriminator Dₘ₃, and adds edge server 230 to an edge server group list 270 for edge server 210. Similarly, at edge server 230, the local GANs training system receives the local discriminator Dₘ₁ from edge server 230, evaluates the area data of edge server 230 with the discriminator Dₘ₁, receives a positive result from discriminator Dₘ₁, and adds edge server 210 to an edge server group list 272 for edge server 230. This processing continues and edge server 210 has an edge server group list 270 with edge servers 230, 240, 250, while edge server 230 has an edge server group list 272 with edge server 210.

Once the edge server group lists have been created, an application may be configured with an edge server group list. For example, in FIG. 2, the edge device 260, as it is approaching the edge server 230, requests and receives an edge server group list 272. In this example, an application model and/or a configuration for the application model does not exist for the application on the edge device 260 or the application model and/or the configuration for the application model exists, but was provided from an edge server that is not on the received edge server group list 272, so the edge device 260 requests and loads the application model and/or the configuration from the edge server 230. Continuing with this example, the device 260, as it is approaching the edge server 210, requests and receives an edge server group list 270. However, the edge device 260 has an application model and/or a configuration that was provided by an edge server on the edge server group list 270, so the edge device 260 does not need to request and load a new application model and/or configuration.

In addition, an existing application model and/or configuration of the application model may be updated based on the application model and/or configuration from another edge server that is on the edge server group list. For example, with reference to the edge server group list 270, 272 of FIG. 2, edge server 210 may obtain application models and/or configurations, while edge server 230 may obtain application models and/or configurations from edge server 210.

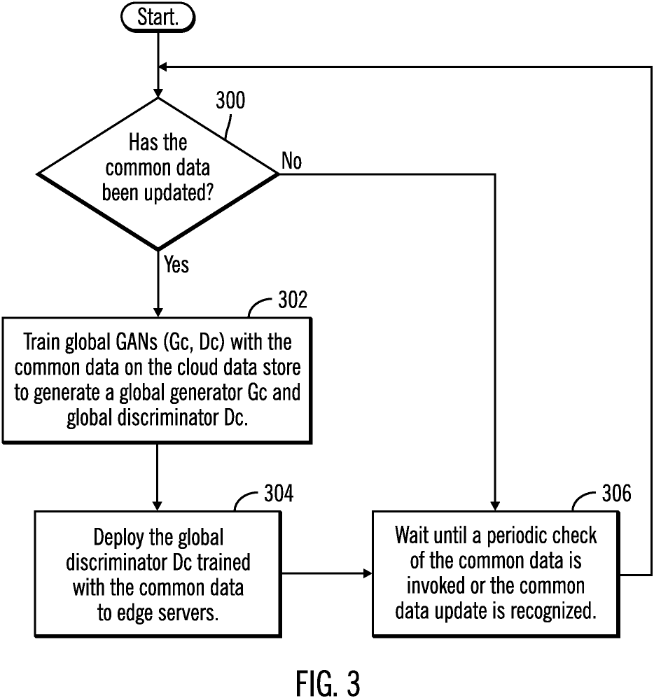

FIG. 3 illustrates, in a flowchart, operations for training a global discriminator and distributing the global discriminator to edge servers in accordance with certain embodiments. Control begins at block 300 with the global GANs training system 102 determining whether the common data has been updated. If so, processing continues to block 302, otherwise, processing continues to block 306. In block 302, the global GANs training system 102 trains the global GANs with the common data on the cloud data store to generate the global generator Gc and the global discriminator D_{c}. In block 304, the global GANs training system 102 distributes the global discriminator D_{c} to edge servers. In certain embodiments, each of the edge servers that receives the global discriminator D_{c} is selected based on one or more features, such as whether that edge server covers a particular area, performs particular operations, etc.

In block 306, the global GANs training system 102 waits until a period check of the common data is invoked or a data update of the common data is recognized. In certain embodiments, the periodic checks are scheduled at predetermined intervals (e.g., every hour).

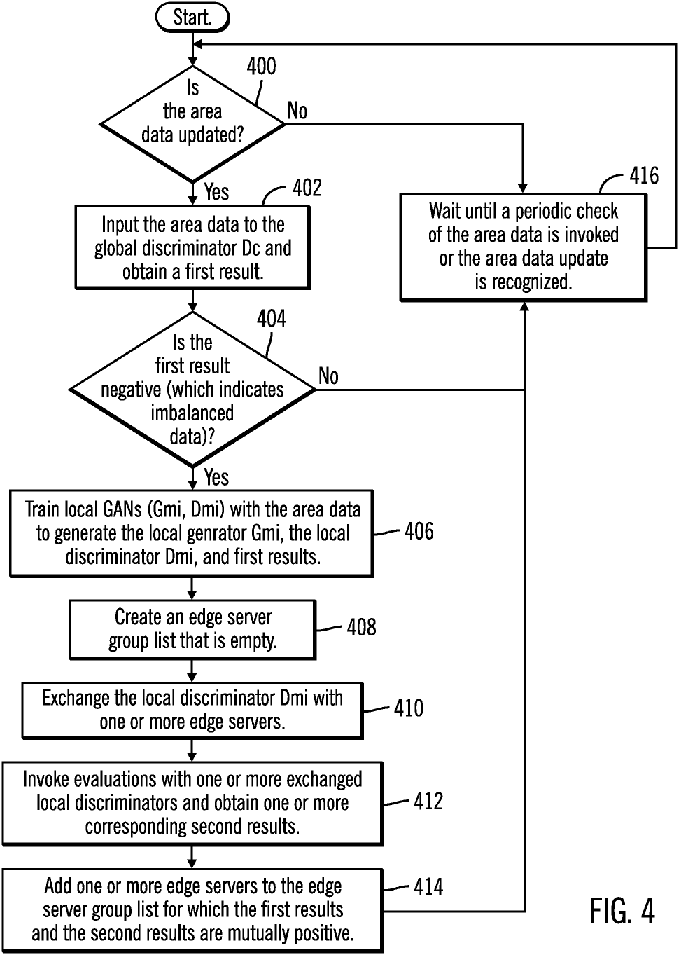

FIG. 4 illustrates, in a flowchart, operations for creating an edge server group list at an edge server in accordance with certain embodiments. Control begins at block 400 with the edge server identification system 122a... 122n determining whether the area data has been updated. If so, processing continues to block 402, otherwise, processing continues to block 416.

In block 402, the edge server identification system 122a... 122n inputs the area data to the global discriminator D_{c} and obtains a first result. In block 404, the edge server identification system 122a... 122n determines whether the first result is negative (which indicates that the area data is imbalanced data). If so, processing continues to block 406, otherwise, processing continues to block 416.

In block 406, the edge server identification system 122a... 122n trains (or invokes the local GANs training system 124a... 124n to train) the local GANs (Gₘᵢ, Dₘᵢ) with the area data to generate local generator Gₘᵢ, the local discriminator Dₘᵢ, and first results. In block 408, the edge server identification system 122a... 122n creates an edge server group list that is empty.

In block 410, the edge server identification system 122a... 122n exchanges the local discriminator Dmᵢ with one or more edge servers. The one or more edge servers are ones where the result of inputting the area data of that edge server into the global discriminator Dc produces a negative result. In certain embodiments, the one or more edge servers are adjacent edge servers.

In block 412, the edge server identification system 122a... 122n invokes evaluations (or invokes the local GANs training system 124a... 124n to invoke evaluations) with one or more exchanged local discriminators and obtains one or more corresponding second results.

In block 414, the edge server identification system 122a... 122n adds one or more edge servers to the edge server group list for which the first results and the second results are mutually positive. For example, the first results from Dₘᵢ at edge server 210 and second results from Dₘ₃ (received from edge server 230) are compared.

In block 416, the edge server identification system 122a... 122n waits until a period check of the area data is invoked or a data update of the area data is recognized. In certain embodiments, the periodic checks are scheduled at predetermined intervals (e.g., every hour).

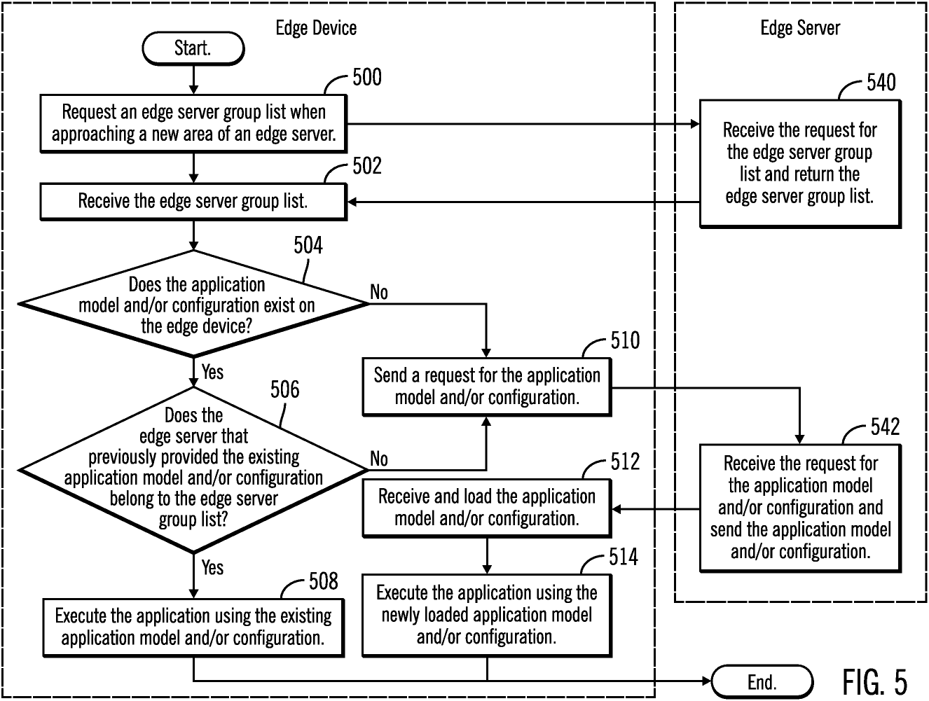

FIG. 5 illustrates, in a flowchart, operations for executing an application on an edge device in accordance with certain embodiments. With embodiments, the application model of the application may be configured on the edge device while reducing the transaction of loading the application model and/or configuration. For example, when an edge device checks whether the edge server that previously provided the existing application model and/or configuration belongs to the edge server group list, the edge device may check whether the existing application model may be used from a cache when the edge device is entering a new area of the edge server.

Control begins at block 500 with an edge server identification system 152c... 152r requesting an edge server group list from an edge server when approaching a new area of that edge server. For example, as an edge device is moving along a path, as the edge device detects a new edge server, the edge device request the edge server group list. Since the edge device may pass multiple edge servers along the path, the edge device may perform the processing of FIG. 5 with each of the edge servers or with a subset of the edge servers based on certain factors (such as time since last configuration). In block 540, the edge server identification system 122a... 122n of the edge server receives the request for the edge server group list and returns the edge server group list to the edge device. In block 502, the edge server identification system 152c... 152r receives the edge server group list.

In block 504, the edge server identification system 152c... 152r determines whether the application model and/or configuration exists on the edge device. If so, processing continues to block 506, otherwise, processing continues to block 510.

In block 506, the edge server identification system 152c... 152r determines whether the edge server that previously provided the existing application model and/or configuration belong to the edge server group list. If so, processing continues to block 508, otherwise, processing continues to block 510.

In block 508, the application executes using the existing application model and/or configuration.

In block 510, the edge server identification system 152c... 152r sends a request for the application model and/or configuration to the edge server (identified in block 500). In block 542, the edge server identification system 122a... 122n of the edge server receives the request for the application model and/or configuration and returns the application model and/or configuration. In block 512, the edge server identification system 152c... 152r receives and loads the application model and/or configuration. In block 512, the application executes using the newly loaded application model and/or configuration.

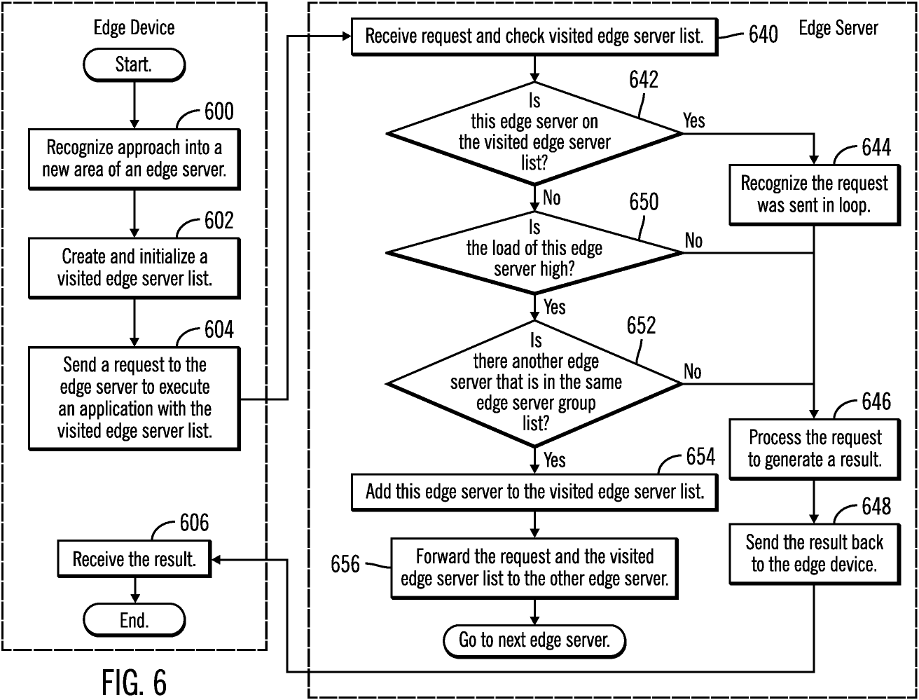

FIG. 6 illustrates, in a flowchart, operations for executing an application on an edge server in accordance with certain embodiments. In these embodiments, the edge device forwards a request to execute an application to an edge server in a coverage area. The edge server either executes the request or forwards the request to another edge server on an edge server group list.

Control begins at block 600 with the edge server identification system 152c... 152r recognizing that the edge device is approaching (or entering) a new area covered by an edge server. That is, as the edge device is traversing a path, the edge device enters the new area covered by the edge server.

In block 602, the edge server identification system 152c... 152r creates and initializes a visited edge server list. In block 604, the edge server identification system 152c... 152r sends a request to the edge server to execute an application with the visited edge server list.

In block 606, the edge server identification system 152c... 152r receives a result. For example, for an application with an image recognition model for the control of an autonomous vehicle, the request may include an image captured by the on-board camera, and the result may be a list of identified objects (e.g., human, dog, red light signal), etc.

In block 640, the edge server identification system 122a... 122n of the edge server receives the request and checks the visited edge server list. In block 642, the edge server identification system 152c... 152r determines whether the edge server (which received the request) is on the visited edge server list. If the edge server is on the visited edge server, that means the request is sent in a closed loop of edge servers and, therefore, the edge server identification system 152c... 152r avoids a loop. If the edge server is on the visited edge server list, processing continues to block 644, otherwise, processing continues to block 650.

In block 644, the edge server identification system 152c... 152r recognizes the request was sent in loop. In block 646, the edge server identification system 152c... 152r processes the request to generate a result. This includes executing the application. In block 648, the edge server identification system 152c... 152r sends the result back to the edge device.

In block 650, the edge server identification system 152c... 152r determines whether the load of this edge server is high. If so, processing continues to block 652, otherwise, processing continues to block 646. The load being high indicates that the edge server is performing many operations and is very busy.

In block 652, the edge server identification system 152c... 152r determines whether there is another edge server that is in the same edge server group list. If so, processing continues to block 654, otherwise, processing continues to block 646.

In block 654, the edge server identification system 152c... 152r adds this edge server (that received the request) to the visited edge server list.

In block 656, the edge server identification system 152c... 152r forwards the request and the visited edge server list to the other edge server.

Then, the other edge server performs the processing of the request, which includes recognizing that the other edge server is on the visited edge server list and is to process the request, without checking whether the load is high.

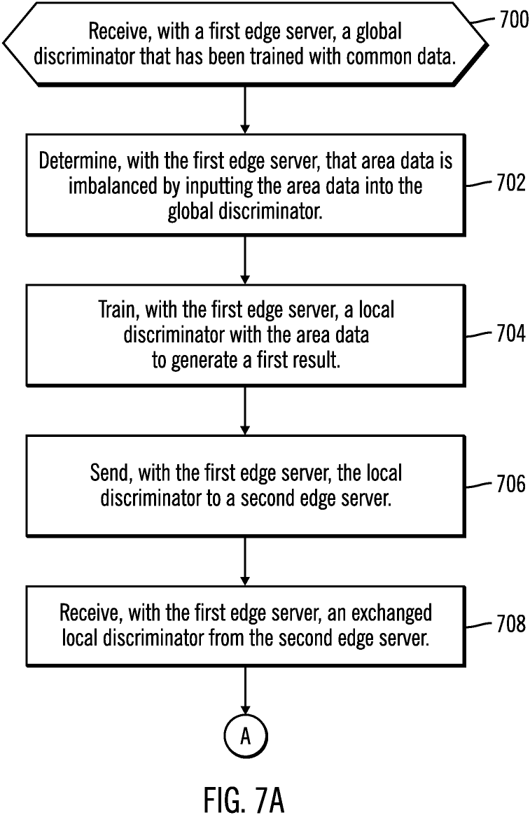

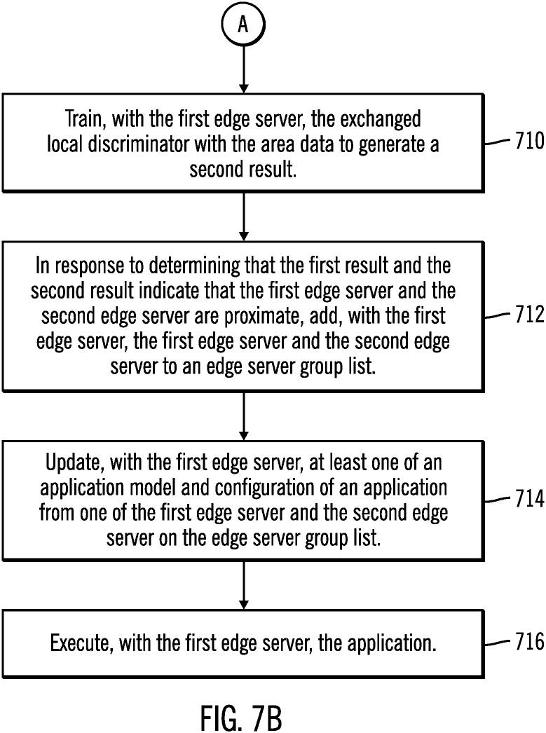

FIGS. 7A and 7B illustrate, in a flowchart, operations for updating an application model and configuration of that application model and executing an application in accordance with certain embodiments. Control begins at block 700 with a first edge server receiving a global discriminator that has been trained with common data. In block 702, the first edge server determines that area data is imbalanced by inputting the area data into the global discriminator. That is, the first edge server determines that area data is imbalanced using the global discriminator.

In block 704, the first edge server trains a local discriminator with the area data to generate a first result. In block 706, the first edge server sends the local discriminator to a second edge server. In block 708, the first edge server receives an exchanged local discriminator from the second edge server. From block 708 (FIG. 7A), processing continues to block 710 (FIG. 7B).

In block 710, the first edge server trains the exchanged local discriminator with the area data to generate a second result. In block 712, in response to determining that the first result and the second result indicate that the first edge server and the second edge server are proximate, the first edge server adds the first edge server and the second edge server to an edge server group list. In block 714, the first edge server, updates an application model and configuration of an application from one of the first edge server and the second edge server on the edge server group list. In block 716, the first edge server, executes the application with the updated application model and configuration.

In certain embodiments, the first edge server sends the local discriminator to a plurality of edge servers. In certain embodiments, the first edge server receives an exchanged local discriminator from each of a plurality of edge servers. Then, the processing of blocks 710 and 712 is performed with each exchanged local discriminator. Additionally, in block 714, the application model and/or configuration may be obtained from any of the edge servers on the edge server group list.

Data-driven edge services or applications that use application models with area data that is imbalanced may cause application errors. However, embodiments provide a technique for detecting whether the data of an edge server in a particular area is imbalanced or not. Embodiments are able to determine whether the area data is imbalanced without collecting the data on the edge server and analyzing that data.

Although a determination may be made of whether the area data on an edge server is imbalanced or not by comparing the area data with common data, this involves transferring the area data from the edge server to the cloud node, which is not cost-effective and involves a security risk. Embodiments provide a technique to determine whether the area data is imbalanced without transferring the area data to the cloud node.

Additionally, whether the area data on the edge server is imbalanced or not may be detected by performing statistical analysis of the data on the edge server and comparing the result with one of common data. However, the statistical analysis is typically performed by data scientists with domain knowledge of the area data and detailed knowledge of the analysis. Embodiments provide a technique to determine whether the area data is imbalanced without such domain knowledge and detailed knowledge of the analysis.

Embodiments use federated learning with GANs, which has the ability to detect whether the area data is imbalanced data without data transfer and without domain knowledge and detailed knowledge of the analysis.

Embodiments avoid the risk of application error by identifying the imbalanced data area. For example, the imbalanced data area data may indicate an area where fog often appears although fog does not appear in the neighboring areas.

When the application is executing at an end-point, embodiments reduce the number of interactions between end-point devices and edge servers because the application model or configuration of the application model may be shared among the edge servers on the edge server group list.

When the application is executing on an edge server, embodiments perform load balancing by transferring requests from the end-point devices to other edge servers on the edge server group list.

Thus, embodiments train a global discriminator with common data on the cloud node and deploy the trained, global discriminator to edge servers. Embodiments input area data into the global discriminator, receive an output from the global discriminator, and determine whether each edge server has imbalanced data based on the output. In particular, if the output of the global discriminator is negative, it is determined that the area data in that edge server is imbalanced. In addition, on each of edge servers that has area data that is imbalanced, a local discriminator is trained with the area data that is imbalanced. Then, the local discriminator is exchanged between adjacent edge servers that have area data that is imbalanced (as determined by the global discriminator). On each of the edge servers having the area data that is imbalanced, an edge server group list is created based on the output of the exchanged local discriminators. The edge servers on a particular edge servers group list have proximate data. In particular, the area data of a first edge server is input to an exchanged local discriminator (i.e., a local discriminator from a second edge server), the area data of the second edge server is input to the exchanged local discriminator (i.e., a local discriminator from the first edge server), and, if the output of both discriminators are similar, then the first edge server and the second edge server are similar (proximate) and are added to a edge server group list.

In certain embodiments, an edge server sends the edge server group list to an edge device entering into an area covered by the edge server. If the edge device does not have the application model and configuration corresponding to an edge server on the edge server group list, the edge server sends the application model and configuration corresponding to the edge server group list to the edge device.

In certain embodiments, the edge server receives a request to execute the application from an edge device. If the load of that edge server is high, the edge server forwards the request to another edge server on the edge server group list with that edge server to perform load balancing.

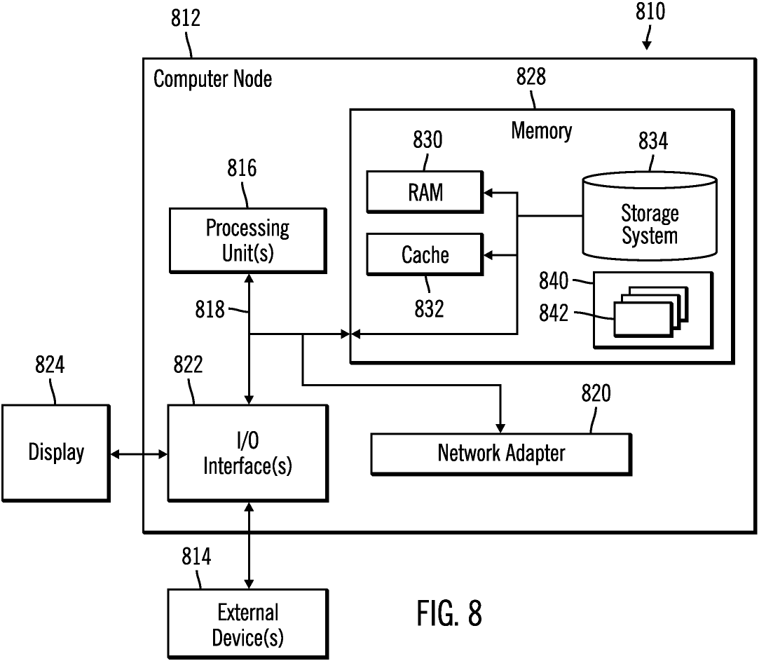

FIG. 8 illustrates a computing environment 810 in accordance with certain embodiments. In certain embodiments, the computing environment is a cloud computing environment. Referring to FIG. 8, computer node 812 is only one example of a suitable computing node and is not intended to suggest any limitation as to the scope of use or functionality of embodiments of the invention described herein. Regardless, computer node 812 is capable of being implemented and/or performing any of the functionality set forth hereinabove.

The computer node 812 may be a computer system, which is operational with numerous other general purpose or special purpose computing system environments or configurations. Examples of well-known computing systems, environments, and/or configurations that may be suitable for use with computer node 812 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer node 812 may be described in the general context of computer system executable instructions, such as program modules, being executed by a computer system. Generally, program modules may include routines, programs, objects, components, logic, data structures, and so on that perform particular tasks or implement particular abstract data types. Computer node 812 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 8, computer node 812 is shown in the form of a general-purpose computing device. The components of computer node 812 may include, but are not limited to, one or more processors or processing units 816, a system memory 828, and a bus 818 that couples various system components including system memory 828 to one or more processors or processing units 816.

Bus 818 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer node 812 typically includes a variety of computer system readable media. Such media may be any available media that is accessible by computer node 812, and it includes both volatile and non-volatile media, removable and non-removable media.

System memory 828 can include computer system readable media in the form of volatile memory, such as random access memory (RAM) 830 and/or cache memory 832. Computer node 812 may further include other removable/non-removable, volatile/non-volatile computer system storage media. By way of example only, storage system 834 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a compact disc read-only memory (CD-ROM), digital versatile disk read-only memory (DVD-ROM) or other optical media can be provided. In such instances, each can be connected to bus 818 by one or more data media interfaces. As will be further depicted and described below, system memory 828 may include at least one program product having a set (e.g., at least one) of program modules that are configured to carry out the functions of embodiments of the invention.

Program/utility 840, having a set (at least one) of program modules 842, may be stored in system memory 828 by way of example, and not limitation, as well as an operating system, one or more application programs, other program modules, and program data. Each of the operating system, one or more application programs, other program modules, and program data or some combination thereof, may include an implementation of a networking environment. Program modules 842 generally carry out the functions and/or methodologies of embodiments of the invention as described herein.

Computer node 812 may also communicate with one or more external devices 814 such as a keyboard, a pointing device, a display 824, etc.; one or more devices that enable a user to interact with computer node 812; and/or any devices (e.g., network card, modem, etc.) that enable computer node 812 to communicate with one or more other computing devices. Such communication can occur via Input/Output (I/O) interfaces 822. Still yet, computer node 812 can communicate with one or more networks such as a local area network (LAN), a general wide area network (WAN), and/or a public network (e.g., the Internet) via network adapter 820. As depicted, network adapter 820 communicates with the other components of computer node 812 via bus 818. It should be understood that although not shown, other hardware and/or software components could be used in conjunction with computer node 812. Examples, include, but are not limited to: microcode, device drivers, redundant processing units, external disk drive arrays, Redundant Array of Inexpensive Disks (RAID) systems, tape drives, and data archival storage systems, etc.

In certain embodiments, the computing device 100 has the architecture of computer node 812. In certain embodiments, the computing device 100 is part of a cloud infrastructure. In certain alternative embodiments, the computing device 100 is not part of a cloud infrastructure.

### Cloud Embodiments

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service’s provider.

Broad network access: capabilities are available over a network and accessed through standard mechanisms that promote use by heterogeneous thin or thick client platforms (e.g., mobile phones, laptops, and PDAs).

Resource pooling: the provider’s computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider’s applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

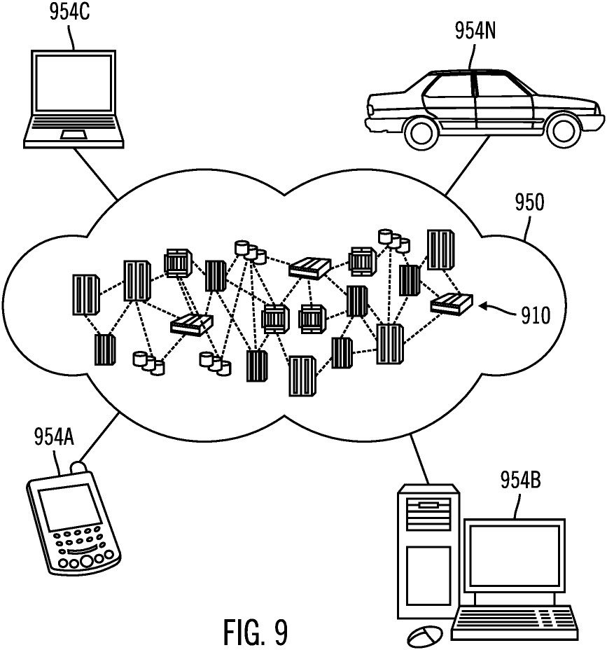

Referring now to FIG. 9, illustrative cloud computing environment 950 is depicted. As shown, cloud computing environment 950 includes one or more cloud computing nodes 910 with which local computing devices used by cloud consumers, such as, for example, personal digital assistant (PDA) or cellular telephone 954A, desktop computer 954B, laptop computer 954C, and/or automobile computer system 954N may communicate. Nodes 910 may communicate with one another. They may be grouped (not shown) physically or virtually, in one or more networks, such as Private, Community, Public, or Hybrid clouds as described hereinabove, or a combination thereof. This allows cloud computing environment 950 to offer infrastructure, platforms and/or software as services for which a cloud consumer does not need to maintain resources on a local computing device. It is understood that the types of computing devices 954A-N shown in FIG. 9 are intended to be illustrative only and that computing nodes 910 and cloud computing environment 950 can communicate with any type of computerized device over any type of network and/or network addressable connection (e.g., using a web browser).

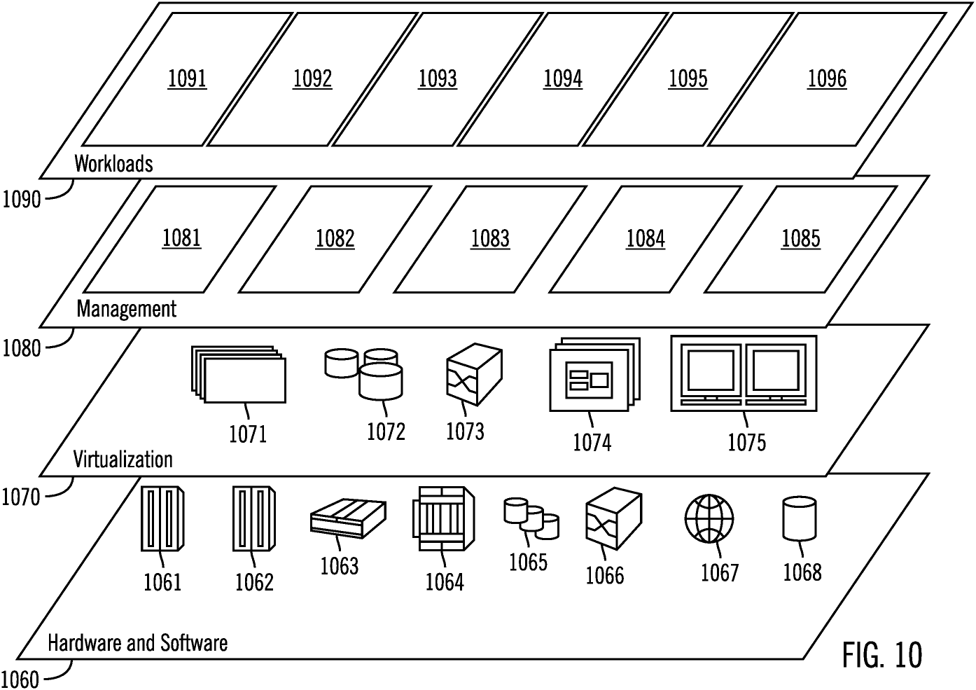

Referring now to FIG. 10, a set of functional abstraction layers provided by cloud computing environment 950 (FIG. 9) is shown. It should be understood in advance that the components, layers, and functions shown in FIG. 10 are intended to be illustrative only and embodiments of the invention are not limited thereto. As depicted, the following layers and corresponding functions are provided:

Hardware and software layer 1060 includes hardware and software components. Examples of hardware components include: mainframes 1061; RISC (Reduced Instruction Set Computer) architecture based servers 1062; servers 1063; blade servers 1064; storage devices 1065; and networks and networking components 1066. In some embodiments, software components include network application server software 1067 and database software 1068.

Virtualization layer 1070 provides an abstraction layer from which the following examples of virtual entities may be provided: virtual servers 1071; virtual storage 1072; virtual networks 1073, including virtual private networks; virtual applications and operating systems 1074; and virtual clients 1075.

In one example, management layer 1080 may provide the functions described below. Resource provisioning 1081 provides dynamic procurement of computing resources and other resources that are utilized to perform tasks within the cloud computing environment. Metering and Pricing 1082 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 1083 provides access to the cloud computing environment for consumers and system administrators. Service level management 1084 provides cloud computing resource allocation and management such that required service levels are met. Service Level Agreement (SLA) planning and fulfillment 1085 provide pre-arrangement for, and procurement of, cloud computing resources for which a future requirement is anticipated in accordance with an SLA.

Workloads layer 1090 provides examples of functionality for which the cloud computing environment may be utilized. Examples of workloads and functions which may be provided from this layer include: mapping and navigation 1091; software development and lifecycle management 1092; virtual classroom education delivery 1093; data analytics processing 1094; transaction processing 1095; and GANs based identification of an edge server 1096.

Thus, in certain embodiments, software or a program, implementing GANs based identification of an edge server in accordance with embodiments described herein, is provided as a service in a cloud environment.

### Additional Embodiment Details

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

00125] The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

In the described embodiment, variables a, b, c, i, n, m, p, r, etc., when used with different elements may denote a same or different instance of that element.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, embodiments of the invention reside in the claims herein after appended. The foregoing description provides examples of embodiments of the invention, and variations and substitutions may be made in other embodiments.

What is claimed is:

1. A computer-implemented method at a first edge server, comprising operations for:
receiving a global discriminator that has been trained with common data;
determining that area data is imbalanced using the global discriminator;
training a local discriminator with the area data to generate a first result;
receiving an exchanged local discriminator from a second edge server;
training the exchanged local discriminator with the area data to generate a second result;
determining that the first result and the second result indicate that the first edge server and the second edge server are proximate;
adding the first edge server and the second edge server to an edge server group list;
updating at least one of an application model and a configuration of an application from one of the first edge server and the second edge server on the edge server group list; and
executing the application.

2. The computer-implemented method of claim 1, further comprising:
under control of the first edge server,
receiving a request to execute the application from an edge device;
determining that a load is high; and
forwarding the request to another edge server on the edge server group list.

3. The computer-implemented method of claim 1, further comprising:
under control of an edge device,
determining that the edge device is approaching an area of coverage of the first edge server;
requesting the edge server group list from the first edge server;
in response to determining that at least one of an application model and a configuration of another application is not from any edge server on the edge server group list, requesting at least one of a new application model and a new configuration from the first edge server; and
executing the another application using the at least one of the new application model and the new configuration.

4. The computer-implemented method of claim 1, wherein an edge device maintains a visited edge servers list while traversing a path that passes by at least one of the first edge server and the second edge server.

5. The computer-implemented method of claim 1, further comprising:
receiving an exchanged local discriminator from a third edge server;
training the exchanged local discriminator from the third edge server with the area data to generate a third result;
determining that the first result and the third result indicate that the first edge server and the third edge server are not proximate.

6. The computer-implemented method of claim 1, wherein the global discriminator outputs a negative result to indicate that the area data is imbalanced and outputs a positive result to indicate that the area data is not imbalanced.

7. The computer-implemented method of claim 1, wherein the global discriminator is trained at a cloud node and deployed to the first edge server.

8. The computer-implemented method of claim 1, wherein a Software as a Service (SaaS) is configured to perform the operations of the computer-implemented method.

9. A computer program product of a first edge server, the computer program product comprising a computer readable storage medium having program code embodied therewith, the program code executable by at least one processor to perform operations for:
receiving a global discriminator that has been trained with common data;
determining that area data is imbalanced using the global discriminator;
training a local discriminator with the area data to generate a first result;
receiving an exchanged local discriminator from a second edge server;
training the exchanged local discriminator with the area data to generate a second result;
determining that the first result and the second result indicate that the first edge server and the second edge server are proximate;
adding the first edge server and the second edge server to an edge server group list;
updating at least one of an application model and a configuration of an application from one of the first edge server and the second edge server on the edge server group list; and
executing the application.

10. The computer program product of claim 9, wherein the program code is executable by the at least one processor to perform operations for:
receiving a request to execute the application from an edge device;
determining that a load is high; and
forwarding the request to another edge server on the edge server group list.

11. The computer program product of claim 9, wherein the program code is executable by the at least one processor to perform operations for:
under control of an edge device,
determining that the edge device is approaching an area of coverage of the first edge server;
requesting the edge server group list from the first edge server;
in response to determining that at least one of an application model and a configuration of another application is not from any edge server on the edge server group list, requesting at least one of a new application model and a new configuration from the first edge server; and
executing the another application using the at least one of the new application model and the new configuration.

12. The computer program product of claim 9, wherein an edge device maintains a visited edge servers list while traversing a path that passes by at least one of the first edge server and the second edge server.

13. The computer program product of claim 9, wherein the program code is executable by the at least one processor to perform operations for:
receiving an exchanged local discriminator from a third edge server;
training the exchanged local discriminator from the third edge server with the area data to generate a third result;
determining that the first result and the third result indicate that the first edge server and the third edge server are not proximate.

14. The computer program product of claim 9, wherein the global discriminator outputs a negative result to indicate that the area data is imbalanced and outputs a positive result to indicate that the area data is not imbalanced.

15. The computer program product of claim 9, wherein the global discriminator is trained at a cloud node and deployed to the first edge server.

16. The computer program product of claim 9, wherein a Software as a Service (SaaS) is configured to perform the operations of the computer program product.

17. A first edge server, comprising:
one or more processors, one or more computer-readable memories and one or more computer-readable, tangible storage devices; and
program instructions, stored on at least one of the one or more computer-readable, tangible storage devices for execution by at least one of the one or more processors via at least one of the one or more computer-readable memories, to perform operations comprising:
receiving a global discriminator that has been trained with common data;
determining that area data is imbalanced using the global discriminator;
training a local discriminator with the area data to generate a first result;
receiving an exchanged local discriminator from a second edge server;
training the exchanged local discriminator with the area data to generate a second result;
determining that the first result and the second result indicate that the first edge server and the second edge server are proximate;
adding the first edge server and the second edge server to an edge server group list;
updating at least one of an application model and a configuration of an application from one of the first edge server and the second edge server on the edge server group list; and
executing the application.

18. The first edge server of claim 17, wherein the operations further comprise:
receiving a request to execute the application from an edge device;
determining that a load is high; and
forwarding the request to another edge server on the edge server group list.

19. The first edge server of claim 17, wherein the operations further comprise:
under control of an edge device connected to the first edge server,
determining that the edge device is approaching an area of coverage of the first edge server;
requesting the edge server group list from the first edge server;
in response to determining that at least one of an application model and a configuration of another application is not from any edge server on the edge server group list, requesting at least one of a new application model and a new configuration from the first edge server; and
executing the another application using the at least one of the new application model and the new configuration.

20. The first edge server of claim 17, wherein an edge device maintains a visited edge servers list while traversing a path that passes by at least one of the first edge server and the second edge server.

21. The first edge server of claim 17, wherein the operations further comprise:
receiving an exchanged local discriminator from a third edge server;
training the exchanged local discriminator from the third edge server with the area data to generate a third result;
determining that the first result and the third result indicate that the first edge server and the third edge server are not proximate.

22. The first edge server of claim 17, wherein the global discriminator outputs a negative result to indicate that the area data is imbalanced and outputs a positive result to indicate that the area data is not imbalanced.

23. The first edge server of claim 17, wherein the global discriminator is trained at a cloud node and deployed to the first edge server.

24. The first edge server of claim 17, wherein a Software as a Service (SaaS) is configured to perform the operations of the first edge server.
